(19) United States
(12) Patent Application Publication
(10) Pub. No.: US 2025/0190883 A1
(43) Pub. Date: Jun. 12, 2025

(54) MULTI-DIMENSIONAL RISK OPTIMIZATION OF PREDICTIVE MODELS

(71) Applicant: International Business Machines Corporation, Armonk, NY (US)

(72) Inventors: Samuel Solomon Ackerman, Haifa (IL); John Thomas Richards, Honeoye Falls, NY (US); Elizabeth Daly, Dublin (IE); Erik Miehling, Dublin (IE)

(21) Appl. No.: 18/536,274

(22) Filed: Dec. 12, 2023

(51) Int. Cl. G06N 20/20

(52) U.S. Cl. CPC G06N 20/20

(57) ABSTRACT

A computer-implemented method comprising: receiving a set of candidate trained machine learning models and a set of evaluation dimensions; generating risk scores for each of the candidate trained machine learning models over each of the evaluation dimensions; determining correlations between the evaluation dimensions based, at least in part, on the generated risk scores; and performing an optimization calculation to identify a subset of the set of candidate trained machine learning models, wherein each of the candidate trained machine learning models in the subset optimizes an overall risk measure over all of the evaluation dimensions, wherein the optimization calculation is based, at least in part, on the determined correlations.

### BACKGROUND

The invention relates to the field of machine learning and artificial intelligence.

Common metrics for assessing the performance of machine learning models include accuracy, precision, and recall. These metrics provide a quantitative measure of the model's performance and reliability, and are used to compare the performance of different models, identify areas for improvement, and understand the real-world performance of the model.

These metrics are central to the evaluation of machine learning models, because machine learning, at its core, is a form of statistical discrimination. However, in certain applications, applying simple statistical discrimination as part of business decision-making may expose users and enterprises to risk associated with bias, lack of fairness, or failure to comply with applicable regulatory requirements, such as privacy guidelines. For example, using machine learning models to make hiring decisions may introduce bias and unfairness into the process, which may not only be regarded as objectionable, but may also be illegal.

Accordingly, users and enterprises may wish to evaluate models on risk-related metrics that are not strictly tied to utility, but rather incorporate additional considerations, such as societal benefit and impact, fairness, bias, compliance with regulatory privacy guidelines, and the like.

In either case, evaluating machine learning models on utility as well as risk-related metrics often must involve input from stakeholders and decision-makers regarding the relative importance of each individual metric. To further complicate matters, evaluation metrics and criteria sometimes present uncorrelated or even conflicting objectives. For example, increasing ‘fairness’ in hiring may require obtaining more personal information about potential candidates, which may then conflict with the need to comply with privacy guidelines.

Therefore, evaluating model risk across multiple evaluation criteria may be characterized as an optimization problem which involves making trade-offs across several evaluation dimensions, to optimize decisions based on constraints set by stakeholders and decision-makers.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment relates to a computer-implemented method comprising: receiving a set of candidate trained machine learning models and a set of evaluation dimensions; generating risk scores for each of the candidate trained machine learning models over each of the evaluation dimensions; determining correlations between the evaluation dimensions based, at least in part, on the generated risk scores; and performing an optimization calculation to identify a subset of the set of candidate trained machine learning models, each of which optimizes an overall risk measure over all of the evaluation dimensions, wherein the optimization calculation is based, at least in part, on the determined correlations.

Another embodiment relates to a system comprising at least one hardware processor; and a non-transitory computer-readable storage medium having program code embodied therewith, the program code executable by the at least one hardware processor to: receive a set of candidate trained machine learning models and a set of evaluation dimensions, generate risk scores for each of the candidate trained machine learning models over each of the evaluation dimensions, determine correlations between the evaluation dimensions based, at least in part, on the generated risk scores, and perform an optimization calculation to identify a subset of the set of candidate trained machine learning models, each of which optimizes an overall risk measure over all of the evaluation dimensions, wherein the optimization calculation is based, at least in part, on the determined correlations.

A further embodiment relates to a computer program product comprising a non-transitory computer-readable storage medium having program code embodied therewith, the program code executable by at least one hardware processor to: receive a set of candidate trained machine learning models and a set of evaluation dimensions; generate risk scores for each of the candidate trained machine learning models over each of the evaluation dimensions; determine correlations between the evaluation dimensions based, at least in part, on the generated risk scores; and perform an optimization calculation to identify a subset of the set of candidate trained machine learning models, each of which optimizes an overall risk measure over all of the evaluation dimensions, wherein the optimization calculation is based, at least in part, on the determined correlations.

In some embodiments, the evaluation dimensions are selected from the group consisting of: accuracy, bias, environmental impact, fairness, toxicity, privacy, legality, accountability, transparency, explainability, predictive performance, uncertainty, interpretability, robustness, training efficiency, memory efficiency, computational efficiency, and security.

In some embodiments, the candidate trained machine learning models are predictive machine learning models.

In some embodiments, the optimization calculation is a multi-objective optimization which optimizes over all of the evaluation dimensions, wherein an optimal solution represents at least one trade-off between two or more conflicting evaluation dimensions of the evaluation dimensions.

In some embodiments, the method further comprises receiving, and the program code is further executable to receive, user selections associated with a series of comparisons between pairs of the machine learning models in the subset, with respect to risk scores associated with two of the evaluation dimensions which are determined to be negatively correlated.

In some embodiments, the method further comprises ranking, and the program code is further executable to rank, the candidate trained machine learning models in the subset, based, at least in part, on the user selections over the series of comparisons.

In some embodiments, the method further comprises training, and the program code is further executable to train, multiple machine learning models, to produce the set of candidate trained machine learning models.

In some embodiments, the risk scores are generated by inferencing the trained machine learning models over one or more provided datasets, to obtain prediction results.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary computing environment, containing an example of an environment for the execution of at least some of the computer code involved in performing the inventive methods, according to an embodiment.

FIG. 2 is a flowchart of a method for model-specific privacy-constraint synthetic data generation from a source database, in accordance with an embodiment.

FIG. 3 is a schematic diagram of the process steps in a method for model-specific privacy-constraint synthetic data generation from a source database, according to an embodiment.

FIG. 4 shows an exemplary Spearman correlation matrix, which measures rank correlation across multiple dimensions.

FIG. 5 shows an exemplary Pareto frontier.

FIG. 6 shows an interactive preference elicitation user interface that presents pairwise comparisons of Pareto-efficient models over two dimensions, to elicit decision-maker preferences.

FIG. 7 illustrates a method for automated evaluation of machine learning model risk across multiple dimensions, to select optimal models based on elicited user preferences.

### DETAILED DESCRIPTION

Disclosed herein is a technique, embodied as a computer-implemented method, a system, and a computer program product, which provides for automated evaluation of machine learning model risk across multiple evaluation dimensions, to select optimal models for a given set of constraints or preferences.

As used herein, the terms ‘machine learning model’ or simply ‘model’ refer broadly to any computer program configured to generate predictions from a previously-unseen dataset. Machine learning models typically are based on one of several machine learning algorithms, which are mathematical methods to find patterns in a set of data. The chosen algorithm undergoes model training using a training dataset, which optimizes the algorithm to make the desired prediction. The resulting function with rules and data structures is then termed the trained machine learning model.

As used herein, the term ‘risk’ refers generally to how problematic a machine learning model prediction is judged to be across one or more risk dimensions, relative to an expected or desired baseline.

Machine learning model risk can be measured over individual ‘dimensions’ of the model, which are measures or aspects of a machine learning model, such as ‘fairness,’ ‘privacy,’ and the like. A machine learning model can have multiple dimensions over which risk can be measured, such that evaluating a model over all of its dimensions is a multi-dimensional problem.

In some embodiments, the present technique provides for a machine learning model evaluation tool configured to evaluate machine learning models across a set of two or more dimensions, based on risk measures associated with each of the dimensions. In some embodiments, the present evaluation tool receives, as input, stakeholder-selected constraints in the form of a set of enumerated dimensions or metrics. In some embodiments, the stakeholder-selected constraints reflect the considered judgment of stakeholders and decision-makers as to the principal or most significant risks associated with, e.g., a business, an enterprise, or any other organization or user, in implementing machine learning model capabilities.

In some embodiments, the present evaluation tool then automatically evaluates candidate machine learning models over the provided constraints, to identify one or more optimal models which minimize overall risk across the set of constraints.

As noted above, machine learning model evaluation dimensions such as ‘fairness’ or ‘bias’ are not purely algorithmic, but rather are human constructs which are subjective in nature. Each of these dimensions may have a risk measure associated with it, which represents the extent by which model results deviate from an expected or desired value. For example, a risk score on ‘fairness’ represents the likelihood that the use of a particular model will lead to disparate treatment, if the outcome of the model varies with respect to members of different groups. Thus, a low ‘fairness’ risk score is desirable to reduce the risk of unfair treatment of disparate groups, wherein the concept of ‘fairness’ is not necessarily tied to traditional measures of model performance or utility, but rather involves subjective, value-based judgment with respect to the risk of causing societal harm.

However, when scoring candidate models on multiple different evaluation dimensions, it is likely that at least some of these dimensions will be uncorrelated or even negatively-correlated. Therefore, it would be difficult to find a single model which minimizes risk across all dimensions. In practice, this means that when choosing between two candidate models M₁ and M₂, a user may find that M₁ has a ‘fairness’ score that is 5% higher than M₂, but a ‘privacy’ score that is 10% lower than M₂. The choice between M₁ and M₂ thus represents a value-based tradeoff between ‘fairness’ and ‘privacy,’ as none of the candidate models optimizes for both. Therefore, the choice must be based on selecting the optimal model from among the candidates, given the relative importance assigned to the various evaluation dimensions by the stakeholders and decision-makers. Accordingly, evaluating models across multiple evaluation dimensions may be characterized as a multi-objective optimization problem which involves making tradeoffs across the evaluation dimensions, based on the business and value judgment of stakeholders and decision-makers.

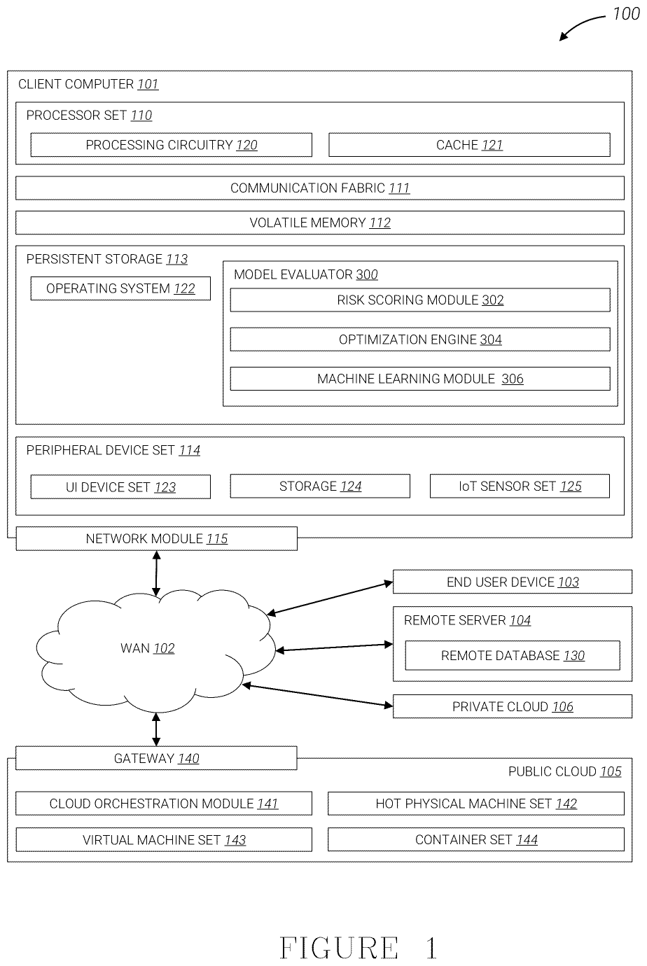

Reference is now made to FIG. 1, which shows a block diagram of an exemplary computing environment 100, containing an example of an environment for the execution of at least some of the computer code involved in performing the inventive methods, such as model evaluator 300, comprising a risk scoring module 302, an optimization engine 304, and/or a machine learning module 306. In addition to block 300, computing environment 100 includes, for example, a computer 101, a wide area network (WAN) 102, an end user device (EUD) 103, a remote server 104, a public cloud 105, and/or a private cloud 106. In this example, computer 101 includes a processor set 110 (including processing circuitry 120 and a cache 121), a communication fabric 111, a volatile memory 112, a persistent storage 113 (including an operating system 122 and block 300, as identified above), a peripheral device set 114 (including a user interface (UI), a device set 123, a storage 124, and an Internet of Things (IoT) sensor set 125), and a network module 115. Remote server 104 includes a remote database 130. Public cloud 105 includes a gateway 140, a cloud orchestration module 141, a host physical machine set 142, a virtual machine set 143, and a container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network and/or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the method(s) specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 300 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as a network interrace controller (NIC), a modem, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through the hardware included in network module 115.

WAN 102 is any wide area network (for example, the Internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

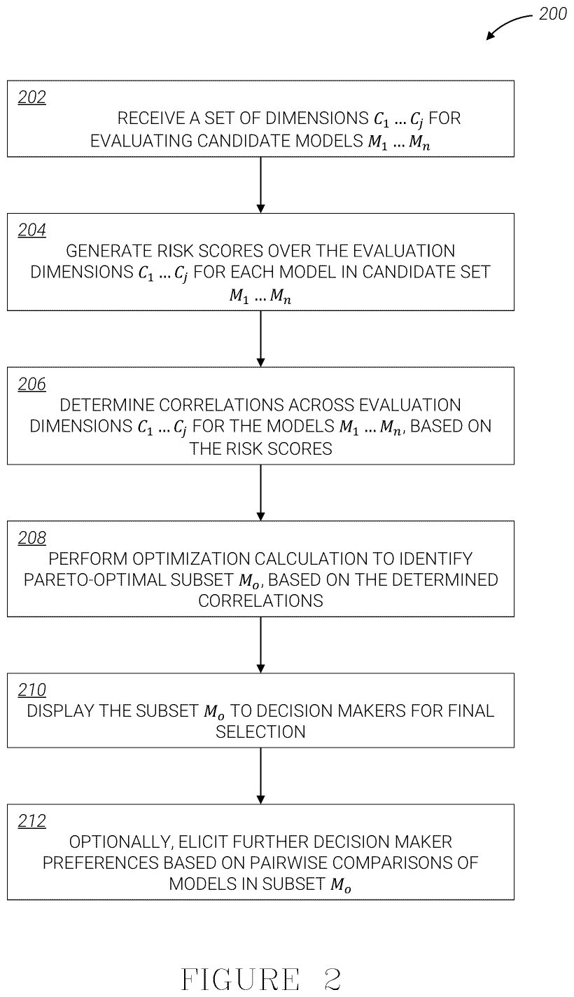

The instructions of model evaluator 300 are now discussed with reference to the flowchart of FIG. 2, which illustrates a method 200 for automated evaluation of machine learning model risk across multiple dimensions, to select optimal models for a given set of constraints or preferences.

Steps of method 200 may either be performed in the order they are presented or in a different order (or even in parallel), as briefly mentioned above, as long as the order allows for a necessary input to a certain step to be obtained from an output of an earlier step. In addition, the steps of method 200 are performed automatically (e.g., by computer 101 of FIG. 1, or by any other applicable component of computing environment 100), unless specifically stated otherwise.

In some embodiments, model evaluator 300 may be used to perform the steps of method 200 to evaluate a set of two or more machine learning model candidates M₁ . . . Mₙ, across a set of given constraints.

Accordingly, in step 202, model evaluator 300 receives, as input, a set of stakeholder constraints. In some embodiments, the stakeholder constraints may be in the form of a set of enumerated dimensions or metrics C₁ . . . Cⱼ for evaluation of models M₁ . . . Mₙ.

In some embodiments, the set of enumerated dimensions or metrics C₁ . . . Cⱼ may reflect the considered judgment of stakeholders as to the principal risks associated with, e.g., a business, an enterprise, or any other organization or user, in implementing machine learning model capabilities.

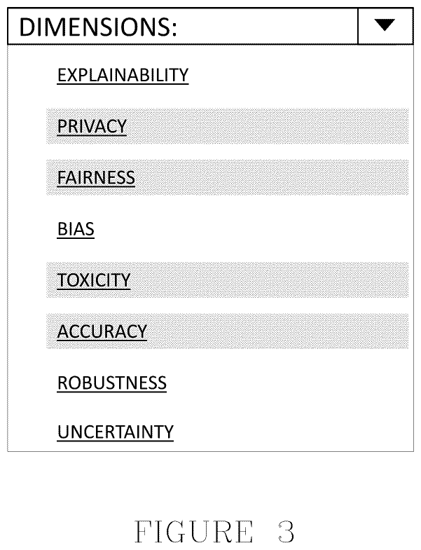

In some embodiments, the stakeholder constraints may be elicited from decision-makers using, e.g., UI device set 123 of system 100. Reference is made to FIG. 3, which shows an exemplary user interface configured for selecting constraints from a predetermined list. In one exemplary implementation, the user interface may allow the selection of multiple dimensions from a dropdown list, as can be seen in FIG. 3. The decision-maker selection is then provided to model evaluator 300 as a set of constraints for evaluating one or more machine learning models thereon.

In some embodiments, a list of possible dimensions for selection by stakeholders may comprise one or more of the following exemplary dimensions:
Accuracy.
Bias.
Environmental impact.
Fairness.
Toxicity.
Privacy.
Legality.
Accountability.
Transparency.
Explainability.
Predictive performance.
Uncertainty.
Interpretability.
Robustness.
Training efficiency.
Memory efficiency.
Computational efficiency.
Security.

However, in other cases, additional and/or other dimensions may be used.

In step 204, the instructions of model evaluator 300 may cause risk scoring module 302 to generate a risk score R over the evaluation dimensions in set C₁ . . . Cⱼ, for each machine learning model in the candidate set M₁ . . . Mₙ. In some embodiments, the instructions of model evaluator 300 may cause risk scoring module 302 to generate a set of risk scores R₁ . . . Rₖ over the evaluation dimensions in set C₁ . . . Cⱼ, for each machine learning model in the candidate set M₁ . . . Mₙ. In some embodiments, the set of risk scores R₁ . . . Rₖ represents risk scores generated over k datasets, across all the evaluation dimensions in set C₁ . . . Cⱼ, for each machine learning model in the candidate set M₁ . . . Mₙ. In one example, this approach can provide for a set of k risk scores over each combination of evaluation dimension/candidate machine learning model, which may enable calculating correlation between evaluation metrics for a given model across the set of risk scores R₁ . . . Rₖ.

Optionally, the risk measures associated with each dimension may be normalized to a standard scale. For example, normalization may comprise representing the risk measures for all dimension on standard scale of 1-100. In some embodiments, any suitable normalization methodology may be employed.

In some embodiments, the risk determination may be performed using one or more provided datasets, over which each of the candidate models is inferenced. For example, the instructions of model evaluator 300 may cause machine learning module 306 to inference each of the candidate models in set M₁ . . . Mₙ over the one or more provided datasets, to obtain prediction results which may be used to assess the performance of each model across the dimensions included in C₁ . . . Cⱼ.

In step 206, the instructions of model evaluator 300 may cause risk scoring module 302 to determine correlations across all of the evaluation dimensions C₁ . . . Cⱼ in each of the models M₁ . . . Mₙ, based, at least in part, on the generated risk score R, or set of risk scores R₁ . . . Rₖ, as the case may be.

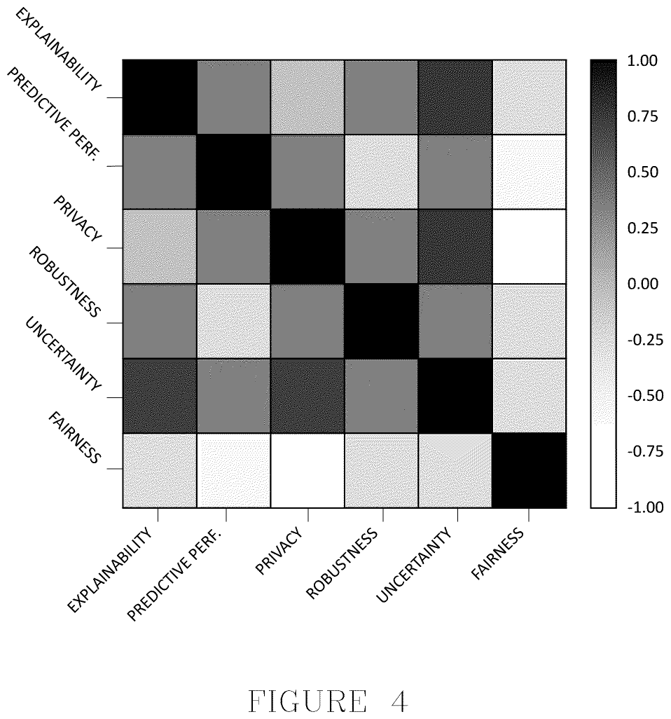

In some embodiments, the correlation determinations may be in the form of a correlation matrix. Reference is made to FIG. 4, which shows an exemplary Spearman correlation matrix, which measures rank correlation across multiple dimensions. The Spearman correlation between two dimensions will be high when observations have a similar or identical (i.e., 1) rank, and low when observations have a dissimilar or fully opposed rank (i.e., −1). As can be seen in FIG. 4, the dimension pair ‘explainability’ and ‘fairness’ has a rank of 1, which means that the pair of dimensions are monotonically related, although the relationship may not be linear. Conversely, the dimension pair ‘explainability’ and ‘privacy’ has a rank of −1, which means that the pair of dimensions are fully opposed.

In step 208, the instructions of model evaluator 300 may cause optimization engine 304 to perform an optimization calculation to identify a subset of the most efficient models Mₒ within candidate set M₁ . . . Mₙ, based, at least in part, on the determined correlations across all of the evaluation dimensions C₁ . . . Cⱼ in each of the models M₁ . . . Mₙ.

In some embodiments, the subset Mₒ of the most efficient models in candidate set M₁ . . . Mₙ represents those models which optimize trade-offs between non-correlated or negatively-correlated dimensions, to minimize the overall cost (risk) of the model, while maximizing performance.

Accordingly, in some embodiments, the instructions of model evaluator 300 may cause optimization engine 304 to perform a multi-objective optimization which calls for two or more dimensions to be optimized simultaneously, wherein optimal solutions represent trade-offs between two or more conflicting objectives, and wherein the purpose of the optimization is to minimize overall cost (risk).

In some embodiments, the instructions of model evaluator 300 may cause optimization engine 304 to perform an optimization calculation to identify a subset Mₒ of the most efficient models in candidate set M₁ . . . Mₙ, given the elicited evaluation dimensions in set C₁ . . . Cⱼ. In some embodiments, the optimization calculation may be a Pareto-optimal solution, wherein all models in the identified optimal subset Mₒ lie on the efficient frontier, wherein none of the identified optimal models dominates the other models in the subset Mₒ.

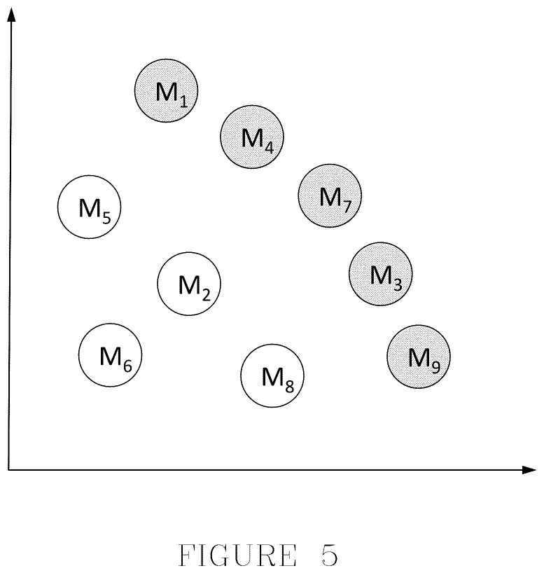

Reference is made to FIG. 5 which shows an exemplary Pareto frontier, wherein models M₁, M₃, M₄, M₇, M₉ from candidate set M₁ . . . Mₙ form a subset Mₒ of Pareto-optimal solutions, and wherein all other models in M₁ . . . Mₙ are non-frontier models. As noted, none of these models is guaranteed to simultaneously optimizes each and every dimension. However, none of the models in subset Mₒ dominates the other models in the subset, in the sense that no single model exceeds any other on any dimension without degrading one or more other dimensions.

Table 1 below shows exemplary risk values associated with each of the Pareto-efficient models in subset Mₒ across the dimensions included in set C₁ . . . Cⱼ.

TABLE 1

| MODEL | ACCURACY | FAIRNESS | TOXICITY | PRIVACY |
|---|---|---|---|---|
| M₁ | 0.72 | 0.86 | 0.05 | 0.88 |
| M₃ | 0.05 | 0.18 | 0.65 | 0.21 |
| M₄ | 0.62 | 0.37 | 0.25 | 0.34 |
| M₇ | 0.34 | 0.67 | 0.331 | 0.22 |
| M₉ | 0.64 | 0.67 | 0.14 | 0.71 |

In step 210, the instructions of model evaluator 300 may cause UI device set 123 to display the subset Mₒ of Pareto-optimal machine learning models to decision-makers for selection of one or more models for deployment.

Optionally, in step 212, the instructions of model evaluator 300 may cause UI device set 123 to employ a preference elicitation methodology to help determine the relative importance of the multiple dimensions measured for each model, to further select between the competing Pareto-optimal models in subset Mₒ.

As noted above, all models in subset Mₒ are Pareto-efficient, such that no model dominates any of the others in the subset. Thus, without additional subjective preference information, all Pareto-optimal solutions may be considered to be equally satisfactory. Accordingly, step 212 is configured to solicit decision-maker input to choose between the equally-optimal models, to reveal the actual relative importance of the multiple dimensions measured for each model.

In some embodiments, the preference soliciting process operates as a series of binary choices presented to a decision-maker, between pairs of Pareto-efficient models over two dimensions, wherein the choice involves subjective judgement regarding the relative importance of each individual dimension.

Accordingly, in some embodiments, the instructions of model evaluator 300 may cause UI device set 123 to elicit decision-maker preference as among the models in subset Mₒ using, e.g., a direct weighting methodology, such as the Analytic Hierarchy Process (AHP) or the Elo rating system. AHP is a multi-criteria method which prompts decision-makers to elicit preferences between a series of pairwise comparisons of options or criteria. For each pair, the decision-maker is asked to choose which option is better or more important, and optionally asked to rate the level of importance on a given scale (e.g., 1-10). With each solicited preference, the weighting or ranking of the individual dimensions is updated, until the process reaches convergence.

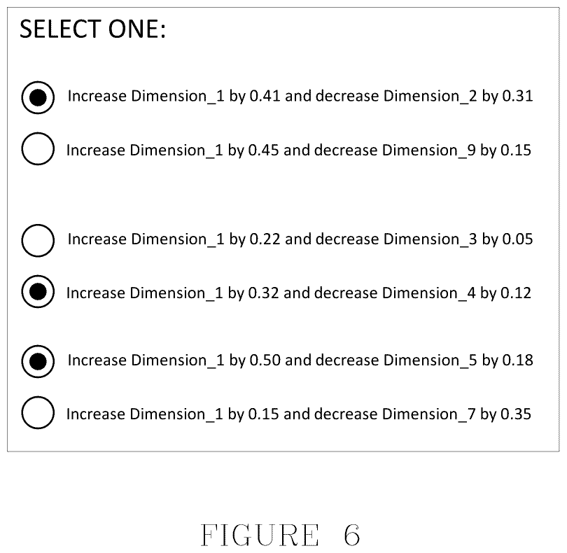

For example, in one implementation, decision-makers may be presented with dimension pairs that have strong negative correlations. Reference is made to FIG. 6, which shows an interactive preference elicitation user interface that presents pairwise comparisons of Pareto-efficient models over two dimensions, to elicit decision-maker preferences.

The pairwise comparisons will typically represent cases in which a first dimension is higher on a first model and lower on the second model, while a second dimension is higher on the second model and lower on the first model.

At the conclusion of step 212, decision-maker preferences are combined to return one or more models from Pareto-optimal subset Mₒ which satisfy decision-maker preferences, for further user selection.

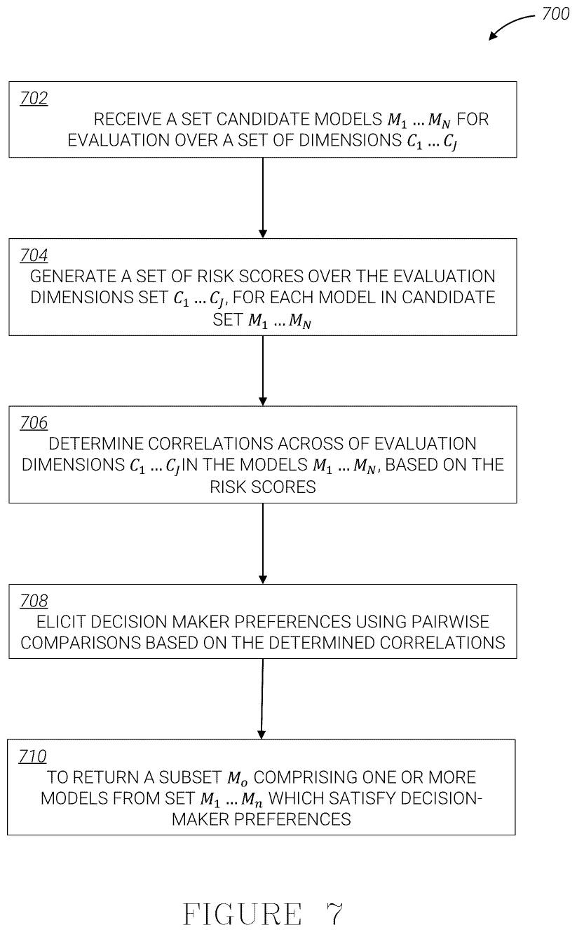

The instructions of model evaluator 300 are now discussed with reference to the flowchart of FIG. 7, which illustrates a method 700 for automated evaluation of machine learning model risk across multiple dimensions, to select optimal models based on elicited user preferences.

Steps of method 700 may either be performed in the order they are presented or in a different order (or even in parallel), as briefly mentioned above, as long as the order allows for a necessary input to a certain step to be obtained from an output of an earlier step. In addition, the steps of method 700 are performed automatically (e.g., by computer 101 of FIG. 1, or by any other applicable component of computing environment 100), unless specifically stated otherwise.

In some embodiments, model evaluator 300 may be used to perform the steps of method 700 to evaluate a set of two or more machine learning model candidates M₁ . . . Mₙ, across a set of given constraints.

Accordingly, in step 702, model evaluator 300 receives, as input, a set of candidate models M₁ . . . Mₙ for evaluation.

In some embodiments, model evaluator 300 is configured to evaluate candidate models M₁ . . . Mₙ over a set of enumerated dimensions or metrics C₁ . . . Cⱼ. In some embodiments, the set of evaluation dimensions may reflect stakeholder-selected constraints in the form of a set of enumerated dimensions or metrics. In some embodiments, the stakeholder-selected constraints reflect the considered judgment of stakeholders as to the principal desiderata associated with, e.g., a business, an enterprise, or any other organization or user, in implementing machine learning model capabilities.

In some embodiments, the stakeholder constraints may be elicited from decision-makers using, e.g., UI device set 123. Reference is made back to FIG. 3, which shows an exemplary user interface configured for selecting constraints from a predetermined list. In one exemplary implementation, the user interface may allow the selection of multiple dimensions from a dropdown list, as can be seen in FIG. 3. The decision-maker selection is then provided to model evaluator 300 as a set of constraints for evaluating one or more machine learning models thereon.

In some cases, a predetermined list of dimensions may be used as set C₁ . . . Cⱼ, which may comprise one or more of the following exemplary dimensions:
Accuracy.
Bias.
Environmental impact.
Fairness.
Toxicity.
Privacy.
Legality.
Accountability.
Transparency.
Explainability.
Predictive performance.
Uncertainty.
Interpretability.
Robustness.
Training efficiency.
Memory efficiency.
Computational efficiency.
Security.

However, in other cases, additional and/or other dimensions may be used.

In step 704, the instructions of model evaluator 300 may cause risk scoring module 302 to generate a risk score R over the evaluation dimensions in set C₁ . . . Cⱼ, for each machine learning model in the candidate set M₁ . . . Mₙ. In some embodiments, the instructions of model evaluator 300 may cause risk scoring module 302 to generate a set of risk scores R₁ . . . Rx over the evaluation dimensions in set C₁ . . . Cⱼ, for each machine learning model in the candidate set M₁ . . . Mₙ. In some embodiments, the set of risk scores R₁ . . . Rₖ represents risk scores generated over k datasets, across all the evaluation dimensions in set C₁ . . . Cⱼ, for each machine learning model in the candidate set M₁ . . . Mₙ. In one example, this approach can provide for a set of k risk scores over each combination of evaluation dimension/candidate machine learning model, which may enable calculating correlation between evaluation metrics for a given model across the set of risk scores R₁ . . . Rₖ.

Optionally, the risk measures associated with each dimension may be normalized to a standard scale. For example, normalization may comprise representing the risk measures for all dimension on standard scale of 1-100. In some embodiments, any suitable normalization methodology may be employed.

In some embodiments, the risk determination may be performed using one or more provided datasets, over which each of the candidate models is inferenced. For example, the instructions of model evaluator 300 may cause machine learning module 306 to inference each of the candidate models in set M₁ . . . Mₙ over the one or more provided datasets, to obtain prediction results which may be used to assess the performance of each model across the dimensions included in C₁ . . . Cⱼ.

In step 706, the instructions of model evaluator 300 may cause risk scoring module 302 to determines correlations across all of the evaluation dimensions C₁ . . . Cⱼ in each of the models M₁ . . . Mₙ, based, at least in part, on the generated risk score R, or set of risk scores R₁ . . . Rₖ, as the case may be.

In some embodiments, the correlation determinations may be in the form of a correlation matrix. Reference is made back to FIG. 4, which shows an exemplary Spearman correlation matrix, which measures rank correlation across multiple dimensions. The Spearman correlation between two dimensions will be high when observations have a similar or identical (i.e., 1) rank, and low when observations have a dissimilar or fully opposed rank (i.e., −1). As can be seen in FIG. 4, the dimension pair ‘explainability’ and ‘fairness’ has a rank of 1, which means that the pair of dimensions are monotonically related, although the relationship may not be linear. Conversely, the dimension pair ‘explainability’ and ‘privacy’ has a rank of −1, which means that the pair of dimensions are not monotonically related.

In step 708, the instructions of model evaluator 300 may cause optimization engine 304 to elicit decision-maker preferences as among the models in candidate set M₁ . . . Mₙ, to help determine the relative importance of the multiple dimensions measured for each model, to further select between the candidate models in set M₁ . . . Mₙ.

In some embodiments, the preference soliciting process operates as a series of binary choices presented to decision-makers between pairs of models over two dimensions, wherein the choice involves subjective judgment regarding the relative importance of each individual metric.

Accordingly, in some embodiments, the instructions of model evaluator 300 may cause UI device set 123 to elicit decision-maker preference as among the models in set M₁ . . . Mₙ using, e.g., a direct weighting methodology, such as the Analytic Hierarchy Process (AHP) or the Elo rating system. AHP is a multi-criteria method which prompts decision-makers to elicit preferences between a series of pairwise comparisons of options or criteria. For each pair, the decision-maker is asked to choose which option is better or more important, and optionally asked to rate the level of importance on a given scale (e.g., 1-10). With each solicited preference, the weighting or ranking of the individual dimensions is updated, until the process reaches convergence.

For example, in one implementation, decision-makers may be presented with dimension pairs that have strong negative correlations. Reference is made back to FIG. 6, which shows an interactive preference elicitation user interface that presents pairwise comparisons of models over two dimensions, to elicit decision-maker preferences.

The pairwise comparisons will typically represent cases in which a first dimension is higher on a first model and lower on the second model, while a second dimension is higher on the second model and lower on the first model.

In step 210, decision-maker preferences are combined to return a subset Mₒ comprising one or more models from set M₁ . . . Mₙ which satisfy decision-maker preferences.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range-10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method comprising:
receiving a set of candidate trained machine learning models and a set of evaluation dimensions;
generating risk scores for each of said candidate trained machine learning models over each of said evaluation dimensions;
determining correlations between said evaluation dimensions based, at least in part, on said generated risk scores; and
performing an optimization calculation to identify a subset of said set of candidate trained machine learning models, wherein each of the candidate trained machine learning models in the subset optimizes an overall risk measure over all of said evaluation dimensions, wherein the optimization calculation is based, at least in part, on said determined correlations.

2. The computer-implemented method of claim 1, wherein said evaluation dimensions are selected from the group consisting of: accuracy, bias, environmental impact, fairness, toxicity, privacy, legality, accountability, transparency, explainability, predictive performance, uncertainty, interpretability, robustness, training efficiency, memory efficiency, computational efficiency, and security.

3. The computer-implemented method of claim 1, wherein said candidate trained machine learning models are predictive machine learning models.

4. The computer-implemented method of claim 1, wherein said optimization calculation is a multi-objective optimization which optimizes over all of said evaluation dimensions, wherein an optimal solution represents at least one trade-off between two or more conflicting evaluation dimensions of said evaluation dimensions.

5. The computer-implemented method of claim 1, further comprising receiving user selections associated with a series of comparisons between pairs of said machine learning models in said subset, with respect to risk scores associated with two of said evaluation dimensions which are determined to be negatively correlated.

6. The computer-implemented method of claim 5, further comprising ranking said candidate trained machine learning models in said subset, based, at least in part, on said user selections over said series of comparisons.

7. The computer-implemented method of claim 1, further comprising training multiple machine learning models, to produce said set of candidate trained machine learning models.

8. The computer-implemented method of claim 1, wherein said risk scores are generated by inferencing said trained machine learning models over one or more provided datasets, to obtain prediction results.

9. A system comprising:
at least one hardware processor; and
a non-transitory computer-readable storage medium having program code embodied therewith, the program code executable by said at least one hardware processor to:
receive a set of candidate trained machine learning models and a set of evaluation dimensions,
generate risk scores for each of said candidate trained machine learning models over each of said evaluation dimensions,
determine correlations between said evaluation dimensions based, at least in part, on said generated risk scores, and
perform an optimization calculation to identify a subset of said set of candidate trained machine learning models, wherein each of the candidate trained machine learning models in the subset optimizes an overall risk measure over all of said evaluation dimensions, wherein the optimization calculation is based, at least in part, on said determined correlations.

10. The system of claim 9, wherein said evaluation dimensions are selected from the group consisting of: accuracy, bias, environmental impact, fairness, toxicity, privacy, legality, accountability, transparency, explainability, predictive performance, uncertainty, interpretability, robustness, training efficiency, memory efficiency, computational efficiency, and security.

11. The system of claim 9, wherein said candidate trained machine learning models are predictive machine learning models.

12. The system of claim 9, wherein said optimization calculation is a multi-objective optimization which optimizes over all of said evaluation dimensions, wherein an optimal solution represents at least one trade-off between two or more conflicting evaluation dimensions of said evaluation dimensions.

13. The system of claim 9, wherein said program code is further executable to receive user selections associated with a series of comparisons between pairs of said machine learning models in said subset, with respect to risk scores associated with two of said evaluation dimensions which are determined to be negatively correlated.

14. The system of claim 13, wherein said program code is further executable to rank said candidate trained machine learning models in said subset, based, at least in part, on said user selections over said series of comparisons.

15. The system of claim 9, wherein said program code is further executable to train multiple machine learning models, to produce said set of candidate trained machine learning models.

16. The system of claim 9, wherein said risk scores are generated by inferencing said trained machine learning models over one or more provided datasets, to obtain prediction results.

17. A computer program product comprising a non-transitory computer-readable storage medium having program code embodied therewith, the program code executable by at least one hardware processor to:
receive a set of candidate trained machine learning models and a set of evaluation dimensions;
generate risk scores for each of said candidate trained machine learning models over each of said evaluation dimensions;
determine correlations between said evaluation dimensions based, at least in part, on said generated risk scores; and
perform an optimization calculation to identify a subset of said set of candidate trained machine learning models, wherein each of the candidate trained machine learning models in the subset optimizes an overall risk measure over all of said evaluation dimensions, wherein the optimization calculation is based, at least in part, on said determined correlations.

18. The computer program product of claim 17, wherein said evaluation dimensions are selected from the group consisting of: accuracy, bias, environmental impact, fairness, toxicity, privacy, legality, accountability, transparency, explainability, predictive performance, uncertainty, interpretability, robustness, training efficiency, memory efficiency, computational efficiency, and security.

19. The system of claim 17, wherein said program code is further executable to receive user selections associated with a series of comparisons between pairs of said machine learning models in said subset, with respect to risk scores associated with two of said evaluation dimensions which are determined to be negatively correlated, and to rank said candidate trained machine learning models in said subset, based, at least in part, on said user selections over said series of comparisons.

20. The system of claim 17, wherein said program code is further executable to train multiple machine learning models, to produce said set of candidate trained machine learning models.
